(19) United States
(12) Patent Application Publication
(10) Pub. No.: US 2017/0238240 A1
(43) Pub. Date: Aug. 17, 2017

(54) COMMUNICATION MANAGEMENT SYSTEMS AND EXPANDED USE OF UNIQUE NETWORK IDENTIFIERS

(71) Applicant: Time Warner Cable Enterprises LLC, New York, NY (US)

(72) Inventor: Don Gunasekara, Reston, VA (US)

(21) Appl. No.: 15/045,562

(22) Filed: Feb. 17, 2016

(51) Int. Cl. H04W 48/10; H04W 64/00

(52) U.S. Cl. CPC H04W 48/10; H04W 64/003

(57) ABSTRACT

According to one configuration, a wireless access point receives a unique network identifier value. The wireless access point assigns the unique network identifier value to a respective wireless network supported by the first wireless access point. Map information maps the unique network identifier value maps to a geographical location in which the first wireless access point resides. For a wireless communication session over the wireless network, the wireless access point provides notification of the unique network identifier value to a remote management resource. The remote management resource uses the received unique network identifier value associated with a current communication session to identify a location of a communication device communicating over the communication session with the wireless access point. For example, the remote management resource utilizes the map information to identify a geographical location associated with the unique network identifier value.

### BACKGROUND

Conventional wireless networks typically include multiple communication resources (such as one or more WiFi™ access points) facilitating wireless communications with one or more mobile communication devices. For example, a conventional wireless network may include: a first wireless access point providing wireless coverage to a first region in a network environment; a second wireless access point providing wireless coverage to a second region in the network environment; and so on.

Each of the wireless access points may be part of the same or different wireless network providing access to a corresponding remote network such as the Internet. Via communications through a selected one of multiple access points, a respective user of a mobile communication device is able to wirelessly communicate through a wireless access point over the Internet.

A wireless network can include multiple sub-networks (such as wireless LANs), each of which is associated with a different name and/or sponsor and, in accordance with the WiFi™ protocol, is assigned a different SSID value. The SSID value (such as a multi-byte character string) assigned to a respective wireless LAN can be any suitable information such as a name of the sponsor or network.

According to conventional techniques, each of multiple wireless sub-networks associated with the wireless access point periodically broadcasts a beacon frame to announce its presence and to relay information, such as timestamp, SSID information, and other parameters regarding the access point to mobile communication devices that are within range. Radio communication devices can be configured to continually scan all 802.11 radio channels and listen for beacons, which facilitate choosing which access point is best to establish a respective wireless association. In other words, subsequent to be informed of available networks, a communication device can select an appropriate network to access the Internet.

Thus, to learn of names (SSIDs) assigned to different available wireless LANs in a network environment, a respective mobile communication device typically monitors an airspace for beacons broadcasted by each of the wireless LANs. Via the one or more beacons, a respective user of a mobile device is made aware of the presence of the multiple different networks in a respective airspace. As mentioned, the user (or the communication device itself) typically selects amongst the available wireless LANs as indicated by corresponding multiple beacons to establish a respective wireless communication link and access the Internet.

### BRIEF DESCRIPTION OF EMBODIMENTS

Embodiments herein deviate with respect to the conventional techniques as previously discussed. For example, embodiments herein expand allocation and use of unique network identifier values. In one embodiment, the generation, distribution, use, etc., of one or more unique network identifier values enables a call handling resource or target recipient to quickly identify a location of a user operating a respective communication device.

More specifically, in accordance with one embodiment, a management resource (such as a service provider) overseeing a respective network of multiple wireless access points generates a unique identifier value to be associated with a geographical region. The management resource initiates assignment of the unique network identifier value to each of one or more wireless access points in the geographical region.

The unique network identifier value can be assigned in any suitable manner. For example, in one embodiment, the management resource initiates distribution of the unique network identifier value over a wireless signal from a communication device located in the geographical region to any listening wireless access points. Upon receiving the network identifier value, during a configuration phase, a respective wireless access point allocates and/or associates the unique network identifier value to a respective wireless network subsequently made available to communication devices in the geographical region. As previously discussed, a wireless access point may provide wireless access to any number of different wireless networks.

In one embodiment, the unique network identifier value is an SSID value (or the like) indicating a unique identity to be assigned or already assigned to the respective wireless network. Subsequent distribution of the assigned/allocated unique network identifier value from the wireless access point in the geographical region indicates availability of the respective wireless network to communication devices in the geographical region.

Note that, in addition to distributing the unique network identifier value, which can be achieved in any suitable manner, the management resource initiates generation of map information. The map information includes an entry mapping the unique network identifier value to corresponding geographical location information. In one embodiment, the corresponding geographical location information (associated with the unique network identifier value) indicates the precise whereabouts of the geographical region in which the respective wireless access point resides. In certain instances, the unique network identifier value is assigned to multiple wireless access points. In such an instance, the map information indicates a geographical region in which each of multiple corresponding wireless access points reside.

In accordance with further embodiments, the management resource initiates distribution of the mapping information for use by a call handling resource. At or around a time that a respective communication device establishes a communication session with the respective wireless access point using the network as indicated by the unique network identifier value, the respective wireless access point conveys message information (one or more messages, signals, etc.) to the call handling resource. In one embodiment, the conveyed message information notifies the call handling resource of the unique network identifier value associated with the network currently used by the communication device to wirelessly communicate with the wireless access point. The call handling resource uses the mapping information to map the unique network identifier value to the corresponding geographical location information assigned to the unique network identifier value and respective wireless access point.

Thus, in this manner, the call handling resource is able to identify, based on the received unique network identifier value associated with a communication session, and location information obtained from mapping, that the communication session is supported by a particular wireless access point and that the communication device resides in a vicinity of the wireless access point.

In accordance with further embodiments, the call handling resource forwards the geographical location information (associated with the established communication session) to a target recipient such as a PSAP (Public-Safety Answering Point) that handles emergency calls.

In addition to providing information regarding attributes of the established communication session such as unique network identifier value, the wireless access point optionally conveys communications (such as voice information, image information, etc.) received over the communication session from the communication device to the target recipient. Accordingly, in addition to being able to communicate via voice, data, etc., communications over a communication session through the wireless access point to the target recipient, via mapping of the unique network identifier value to the appropriate geographical region information, the target recipient is further notified of the particular geographical location in which the communication device and corresponding user aside.

Note that the geographical location information forwarded to the target recipient can include or be any suitable type of information. For example, in one embodiment, the geographical location information includes a multiple-digit string of numbers specifying the geographical location in which the first wireless access point resides. If desired, a first grouping of numbers of the string indicates an area code in which the first wireless access point resides; a second grouping of numbers in the string indicates an exchange within the area code in which the first wireless access point resides; and a third grouping of numbers in the string indicates a specific location of the first wireless access point in which the geographical region resides. Via the geographical location information, the target recipient handling an incoming call over the communication session is able to identify the precise location where the respective communication device is located.

Embodiments herein are useful over the cited prior art. For example, embodiments herein provide a way of more easily tracking a location of a mobile communication device, without needing the mobile communication device to provide a whereabouts (such as via GPS information) of its location.

These and other more specific embodiments are disclosed in more detail below.

Note that any of the resources as discussed herein can include one or more computerized devices, mobile communication devices, servers, base stations, wireless communication equipment, communication management systems, workstations, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including a non-transitory computer-readable storage medium (i.e., any computer readable hardware storage medium or hardware storage media disparately or co-located) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage media such as an optical medium (e.g., CD-ROM), floppy disk, hard disk, memory stick, memory device, etc., or other a medium such as firmware in one or more ROM, RAM, PROM, etc., and/or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, etc., that supports operations as discussed herein.

One embodiment includes a computer readable storage media and/or a system having instructions stored thereon to facilitate expanded use of one or more unique network identifier values over conventional techniques. For example, in one embodiment, the instructions, when executed by computer processor hardware, cause the computer processor hardware (such as one or more processor devices) to: receive a unique network identifier value assigned to the first wireless access point; assign the unique network identifier value to a respective wireless network supported by the first wireless access point, the unique network identifier value mapped to a geographical location in which the first wireless access point resides; and for a wireless communication session over the wireless network, provide notification of the unique network identifier value to a call handling resource (such as a management resource).

Yet another embodiment herein includes computer readable storage media and/or a system having instructions stored thereon to provide expanded use of one or more unique network identifier values over conventional techniques. For example, the instructions, when executed by a respective computer device (computer processor hardware), cause a processor or multiple processors (computer processor hardware) to: receive a unique network identifier value, the unique network identifier value assigned to a first wireless access point of multiple wireless access points in a network environment, the unique network identifier value associated with a corresponding geographical region in which the first wireless access point resides, the unique network identifier value allocated to support conveyance of a predetermined type of communications from the mobile communication device to a target recipient; produce map information mapping the unique network identifier value to the corresponding geographical region in which the first wireless access point resides; and utilize the map information to identify a location of a mobile communication device communicating through the first wireless access point.

Yet another embodiment herein includes computer readable storage media and/or a system having instructions stored thereon to provide expanded use of one or more unique network identifier values over conventional techniques. For example, the instructions, when executed by a respective computer device (computer processor hardware), cause a processor or multiple processors (computer processor hardware) to: receive a unique network identifier value assigned to a geographical location; distribute the unique network identifier value to a wireless access point in the geographical region; transmit the unique network identifier value to the wireless access point in response to receiving a query from the wireless access point; control a power level of wirelessly transmitting a communication including the unique network identifier value to the wireless access point based at least in part on a signal strength of receiving the query from the wireless access point; and produce map information mapping the unique network identifier value to the geographical location.

Yet another embodiment herein includes computer readable storage media and/or a system having instructions stored thereon to provide expanded use of one or more unique network identifier values over conventional techniques. For example, the instructions, when executed by a respective computer device (computer processor hardware), cause a processor or multiple processors (computer processor hardware) to: receive a message from a first wireless access point in the network environment, the first wireless access point communicating the message to the management resource, the message indicates attributes of a corresponding type of wireless communication session between a communication device and the first wireless access point; map a unique network identifier value in the message to geographical location information; and provide notification of the geographical location information to a target recipient.

Yet another embodiment herein includes computer readable storage media and/or a system having instructions stored thereon to provide expanded use of one or more unique network identifier values over conventional techniques. For example, the instructions, when executed by a respective computer device (computer processor hardware), cause a processor or multiple processors (computer processor hardware) to: receive a unique network identifier value assigned to the first wireless access point, the unique network identifier value mapped to location information indicating a location in which the first wireless access point resides; distribute the unique network identifier value to a mobile communication device within wireless communication range of the first wireless access point; and provide notification of the unique network identifier value to a management resource that derives geographical location information from the unique network identifier value.

The ordering of the steps above has been added for clarity sake. Note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of wireless networks and providing expanded usage of assigned unique network identifier values. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section and corresponding figures of the present disclosure as further discussed below.

### BRIEF DESCRIPTION OF THE DRAWINGS

FIG. 1 is an example diagram illustrating a network environment and expanded use of unique network identifier values according to embodiments herein.

FIG. 2 is an example diagram of a communication device according to embodiments herein.

FIG. 3 is an example diagram illustrating map information according to embodiments herein.

FIG. 4 is an example diagram illustrating of a multi-function communication device according to embodiments herein.

FIG. 5 is an example diagram illustrating management of a first communication session and providing notification of location information associated with the first communication session according to embodiments herein.

FIG. 6 is an example diagram illustrating management of a second communication session and providing notification of location information associated with the second communication session according to embodiments herein.

FIG. 7 is an example diagram illustrating a computer architecture in which to execute one or more embodiments as discussed herein.

FIG. 8-11 are example diagrams illustrating various methods according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION

According to one configuration, a wireless access point receives a unique network identifier value assigned by a service provider. The wireless access point uses the unique network identifier value to create a respective wireless network supported by the first wireless access point. The service provider (via one or more resources) generates map information mapping the unique network identifier value to a geographical location in which the first wireless access point resides.

Subsequent to making the respective wireless network available, a communication device uses the unique network identifier value to establish a wireless communication session with the wireless access point. The wireless access point provides notification of the unique network identifier value associated with the newly created communication session to a remote management resource. The remote management resource uses the received unique network identifier value associated with new communication session to identify a location of the corresponding communication device communicating over the communication session with the wireless access point.

In one embodiment, the remote management resource utilizes the map information as discussed above to map the unique network identifier value associated with the communication session to identify a geographical location of the communication device.

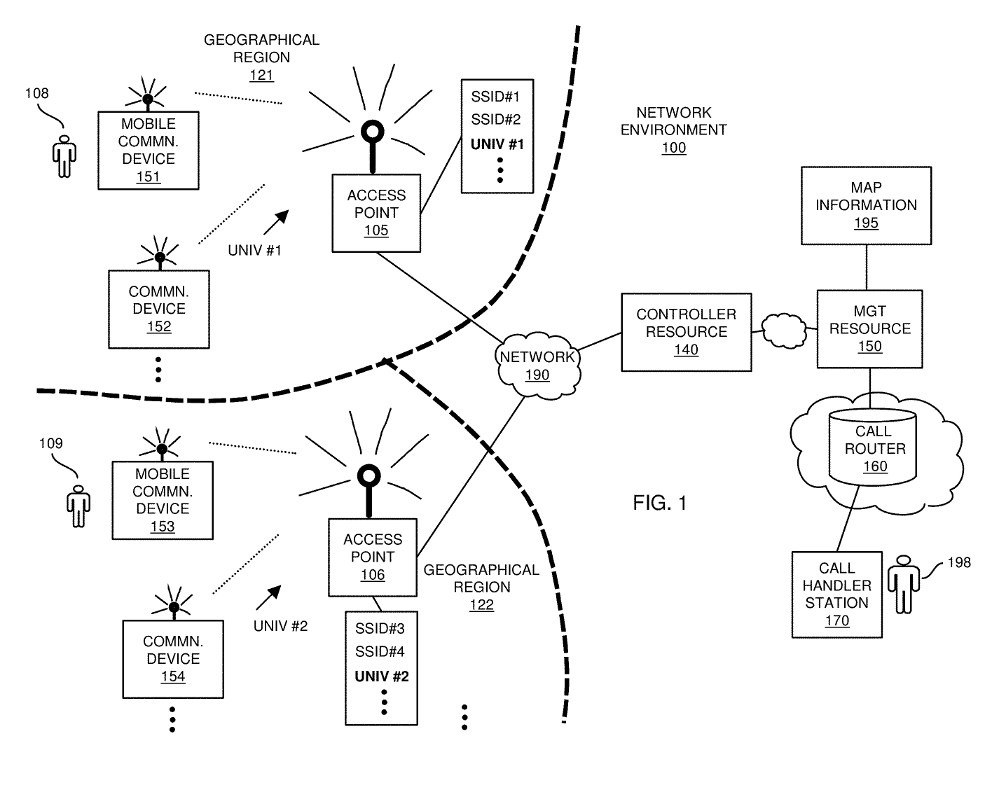

Now, more specifically, FIG. 1 is an example diagram illustrating a network environment and use of unique network identifier values to support location determination according to embodiments herein.

As shown, network environment 100 includes multiple communication devices 151, 152, 153, 154, etc. Additionally, network environment 100 includes an interconnection of resources including multiple wireless access points (such as wireless access point 105, wireless access point 106, . . . ), network 190, controller resource 140, management resource 150, call router 160, and call handler station 170.

By way of a non-limiting example, each of the communication devices 151, 152, 153, 154, etc., can be stationary or mobile. Each of the communication devices establishes a respective wireless link to access communicate with a remote location. In certain instances, a respective communication device may be hardwired to the network 190 and corresponding controller resource 140.

By further way of a non-limiting example, access points can be configured to support any suitable type of wireless communications such as those according to a WiFi™ (i.e., any suitable 802.11 protocol).

In accordance with one embodiment, a suitable entity associated with a service provider oversees network environment 100 including multiple wireless access points. The entity generates a corresponding unique identifier value to be associated with each geographical region in the network environment 100. The service provider entity initiates assignment of the corresponding unique network identifier value to each of one or more wireless access points that happen to reside in the geographical region.

The unique network identifier values can be assigned in any suitable manner. For example, in one embodiment, the service provider entity initiates distribution of a given unique network identifier value (such as unique network identifier value UNIV#1) over a wireless signal from communication device 152 located in the geographical region to any listening wireless access points. Further in this example, communication device 154 communicates unique network identifier value UNIV#2 to wireless access point 106; and so on.

Note that multiple wireless access points may reside in geographical region 121. In such an instance, the communication device 152 can be configured to distribute unique network identifier value #1 (such as ESSID1) to multiple wireless access points in the geographical region 121; the communication device 154 can be configured to distribute unique network identifier value #2 (such as ESSID2) to multiple wireless access points in the geographical region 122; and so on.

Upon receiving the network identifier value, a respective wireless access point allocates and/or associates the unique network identifier value to a respective wireless network subsequently made available to communication devices in the geographical region.

For example, the wireless access point 105 may initially support a first wireless network name SSID #1, a second wireless network name SSID #2, etc. In response to receiving the unique network identifier value UNIV#1 (such as ESSID #1), the wireless access point 105 creates new network named UNIV#1 and adds the SSID value UNIV#1 (or ESSDI1) to its available network identities so that any of the communication devices in wireless communication range of the wireless access point 105 can subsequently select the network named UNIV#1 (ESSID1) to establish a wireless communication link.

As a further example, the wireless access point 106 may initially support wireless network named SSID #3, wireless network name SSID #4, etc. In response to receiving the unique network identifier value UNIV#2 (such as ESSID2), the wireless access point 106 creates new network named UNIV#2 and adds the SSID value UNIV#2 (ESSID2) to its available network identities so that any of the communication devices in wireless communication range of the wireless access point 106 can subsequently select the network named UNIV#2 to establish a wireless communication link.

In addition to distributing the unique network identifier value, which can be achieved in any suitable manner, the service provider associated with the wireless access points produces map information 195. The map information 195 includes an entry mapping the unique network identifier value to respective geographical location information. In one embodiment, the respective geographical location information (stored for the unique network identifier value) indicates the precise or general regional whereabouts of the geographical region in which the respective wireless access point resides.

In accordance with further embodiments, the service provider entity initiates distribution of the mapping information 195 for use by a call handling resource such as management resource 150. Upon detecting that a respective communication device establishes a communication session with a respective wireless access point using a network as indicated by the unique network identifier value UNIV#1, the respective wireless access point 105 conveys message information (one or more messages, signals, etc.) to the management resource 150.

In one embodiment, the conveyed message information notifies the management resource 150 of the unique network identifier value UNIV#1 associated with the network currently used by the communication device 151 to wirelessly communicate with the wireless access point 105. Accordingly, the management resource 150 can be notified of an established communication session associated with the wireless access point 105 and communication device 151.

The management resource 150 uses the mapping information 195 to map the unique network identifier value UNIV#1 associated with the communication session to corresponding geographical location information assigned to the unique network identifier value UNIV#1 and respective wireless access point 105.

Thus, in this manner, the management resource 150 is able to identify, based on the received unique network identifier value UNIV#1 associated with the established communication session between the communication device 151 and the wireless access point 105, and based on location information obtained from map information 195, that the communication session is supported by the respective wireless access point 105 and that the communication device 151 establishing the communication session is located in a vicinity of the geographical region 121. It is known that the wireless access point 105 supports short range communications, meaning that the communication device 151 is within a certain distance of the wireless access point 105.

In accordance with further embodiments, note that the management resource 150 can be configured to forward the retrieved geographical location information to a target recipient such as personnel 198 at call handler station 170. In one embodiment, the personnel 198 include one or more persons trained to manage the type of communications received over the wireless communication session (using UNIV#1) from a user operating the communication device. If desired, the personnel 198 convey information of the call to one or more other remote parties that provide service to the user 108.

As further discussed below, note that the wireless access point optionally conveys communications received over the communication session from the communication device to the target recipient (such as personnel 198). Accordingly, in addition to being able to communicate via voice, data, etc., communications over a communication session through the wireless access point to the target recipient, the target recipient is further notified of the particular geographical location in which the communication device 151 and corresponding user 108 reside.

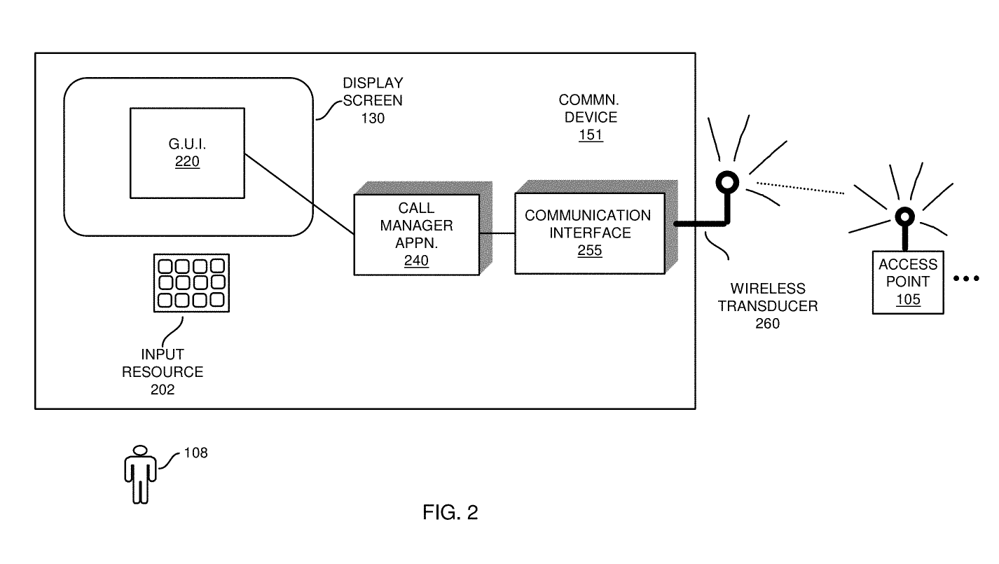

FIG. 2 is an example diagram illustrating a communication device configured to connect to and communicate over a wireless access point according to embodiments herein.

As shown, the communication device 151 (e.g., any type of computer device) used by a respective user 108 can include appropriate hardware and software supporting functions such as establishing a communication connection with a wireless access point to place a call alert and establish a call connection.

As a specific example, in this example, user 108 provides input to the communication device 151 via input resources 202. Input resources 202 can include a keyboard, touch-screen interface, microphone, computer mouse, mouse pad, etc., enabling the user 108 to control operations of communication device 151.

Assume in this example that the user 108 provides input selecting execution of the call manager application 240. Execution of the call manager application 240 enables the user 108 to make a respective call to any of one or more different target entities capable of providing aid to user 108.

In this example, the input causes the call manager application 240 to launch respective graphical user interface 220 (such as associated with a browser, call management application, etc.) for display on display screen 130. In response to receiving further user input, such as input to the graphical user interface 220 to contact one or more remotely located persons, the call manager application 240 controls communication interface 255 to establish a call connection with a corresponding remote location. In one embodiment, this includes establishing a communication session with wireless access point 105. As discussed below, when establishing the call connection, the call manager application 240 can be configured to identify an appropriate network (amongst multiple available networks) in which to establish a communication session in order to connect the user 108 with a desired target.

By further way of a non-limiting example, each of the communication devices as described herein can be or include any suitable resource such as a mobile communication device, phone, personal computer system, a wireless device, base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, wireless transducer 260, etc.

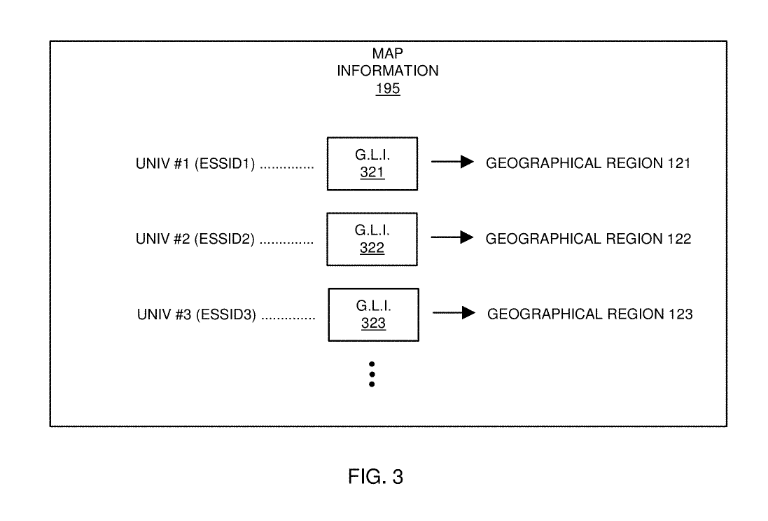

FIG. 3 is an example diagram illustrating map information according to embodiments herein.

As shown in this example embodiment, the map information 195 maps a corresponding unique network identifier value assigned to a respective wireless access point (and communication sessions) to corresponding geographical location information indicating a respective geographical region in which the corresponding wireless access point resides.

More specifically, the map information 195 maps the unique identifier value UNIV#1 (such as ESSID1) to corresponding geographical location information 321. The geographical location information 321 includes information indicating the location of geographical region 121.

The map information 195 maps the unique identifier value UNIV#2 to corresponding geographical location information 322. Geographical location information 322 includes information indicating the location of geographical region 122.

The map information 195 maps the unique identifier value UNIV#3 to corresponding geographical location information 323. Geographical location information 323 includes information indicating the location of geographical region 123.

Note that the geographical location information can include any suitable type of information. For example, the location information can include information and/or attributes such as street names, building names, address information, zip code information, telephone information, geographical latitude-longitude coordinates, etc.

In one embodiment, the geographical location information includes a multiple-digit string of numbers or symbols specifying the geographical location in which a respective wireless access point (assigned a corresponding unique network identifier value) happens to reside.

Note that the multiple-digit number can be formatted similar to a phone number in which each of multiple different groupings of numbers in the string correspond to a successively more specific location of the geographical region in which the first wireless access point.

For example, in accordance with one non-limiting example embodiment, a first grouping of numbers of the string can be configured to indicate an area code in which a corresponding wireless access point resides; a second grouping of numbers in the string can be configured to indicate an exchange within the area code in which the corresponding wireless access point resides; a third grouping of numbers in the string can be configured to indicate a specific location of the corresponding wireless access point in which the geographical region resides, and so on.

In one embodiment, the geographical location information associated with a unique network identifier value is a fictitious phone number. For example, the geographical location information 321 may include the number 617-234-5678; the geographical location information 322 may include the number 508-765-4321; and so on. In one embodiment, one is not able to call the number 617-234-5678 or 508-123-4567 to establish a call connection with the geographical region. However, the phone number format enables a respective recipient to identify a corresponding location associated with a unique network identifier value.

As a further example, assume that the geographical location information 321 associated with unique network identifier value UNIV#1 assigned to wireless access point 105 includes the numerical sequence 617-234-5678. In such an instance, the value “617” indicates that corresponding geographical region 121 resides within a geographical region covered by area code “617.” The prefix value “234” indicates a particular city within the area code “617”. The value “5678” corresponds to a specific location within the particular city indicated by the prefix “234.”

As a another example, assume that the geographical location information 322 associated with unique network identifier value UNIV#2 assigned to wireless access point 106 includes the numerical sequence 508-765-4321. In such an instance, the value “508” indicates that corresponding geographical region 122 resides within a geographical region covered by area code “508.” The prefix value “765” indicates a particular city within the area code “508”. The value “4321” corresponds to a specific location within the particular city indicated by the prefix “765.”

In this manner, each of the unique network identifier values can be correlated to a respective geographical region in the network environment 100.

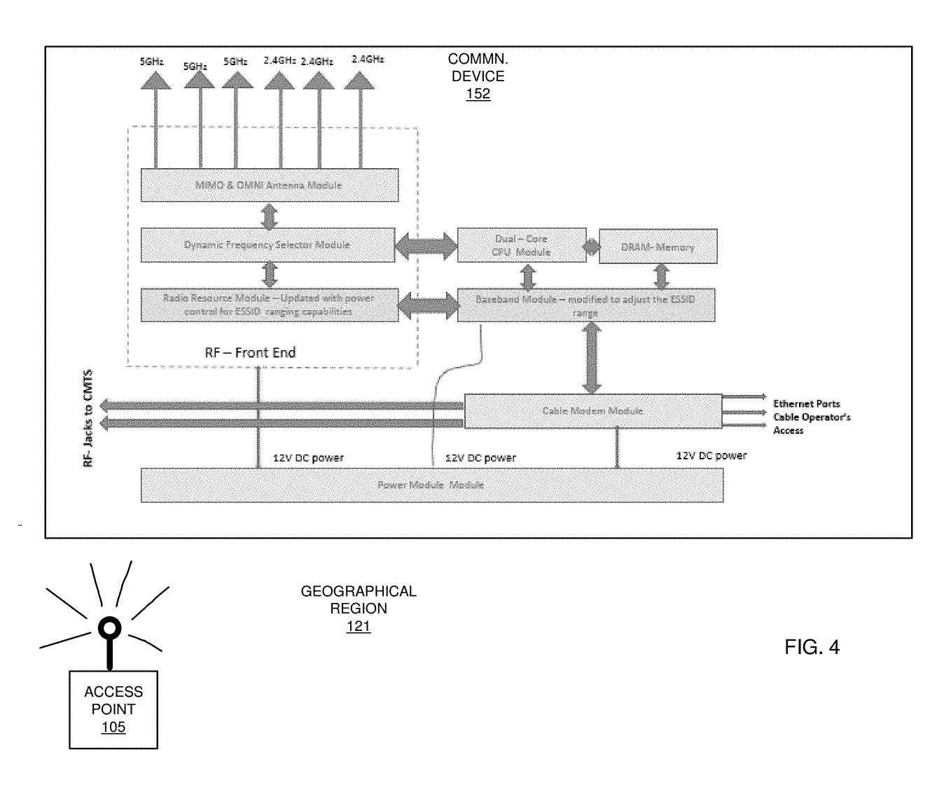

FIG. 4 is an example diagram illustrating a multi-function communication device according to embodiments herein.

As previously discussed, each of one or more communication devices can be configured to distribute unique network identifier values (such as ESSIDs) to wireless access points in a given geographical region.

In one embodiment, the communication device 152 is a mini wireless access point.

As a further example, the communication device 152 receives a unique network identifier value UNIV#1 assigned to geographical location 121 by the service provider. In response to receiving a wireless inquiry from the wireless access point 105, the communication device 152 in this example transmits the unique network identifier value UNIV#1 to the wireless access point 105. Accordingly, the communication device 152 can be configured to respond with a message to the wireless access point 105 indicating the unique network identifier value UNIV#1 assigned to the corresponding geographical region 121.

In one embodiment, the communication device 152 controls and/or varies a power level of wirelessly transmitting communications including the unique network identifier value UNIV#1 to the wireless access points in the geographical region 121 based at least in part on a signal strength of receiving wireless queries from the one or more wireless access points in the geographical region 121.

More specifically, referring again to FIG. 1, as previously discussed, multiple wireless access points may reside in geographical region 121; multiple wireless access points may reside in geographical region 122; and so on.

To ensure that the communication device 152 does not assign the unique network identifier value UNIV#1 to wireless access point 106 in geographical region 122, the communication device 152 can be configured to adjust a power level of wirelessly transmitting communications including the unique network identifier value UNIV#1 to control which of multiple wireless access points are assigned the unique network identifier value. Increasing the power level of a respective wireless response (from the communication device 152) including the unique network identifier value UNIV#1 means that more wireless access points located in the network environment 100 will be assigned the unique network identifier value UNIV#1. Decreasing the power level of a respective wireless response including the unique network identifier value UNIV#1 means that fewer wireless access points located in the network environment 100 will be assigned the unique network identifier value UNIV#1.

Thus, via controlling power levels of distributing the unique network identifier values, the communication devices 152, 154, etc., in the network environment 100 are able to control the size of the geographical region in which one or more wireless access points are assigned the same unique network identifier value.

The communication devices 152, 154, etc., optionally communicate with the controller resource 140 to indicate which of the communication devices have been notified of a respective geographical region in which they reside. From this information, the controller resource 140 can be configured to identify which if any of the wireless access points in the network environment 100 have not yet been assigned a unique network identifier value. In such an instance, the controller resource 140 can be configured to notify the communication device to increase its respective power level of transmitting a respective unique network identifier value so that each of the wireless access points in the network environment 100 are assigned to a respective geographical region.

As previously discussed, distribution of the unique network identifier value UNIV#1 to the wireless access point 105 notifies the wireless access point 105 that the unique network identifier value UNIV#1 is assigned for use by the wireless access point 105 to support communications with mobile communication devices in the geographical region 121; distribution of the unique network identifier value UNIV#2 to the wireless access point 106 notifies the wireless access point 106 that the unique network identifier value UNIV#2 is assigned for use by the wireless access point 106 to support communications with mobile communication devices in the geographical region 121; and so on.

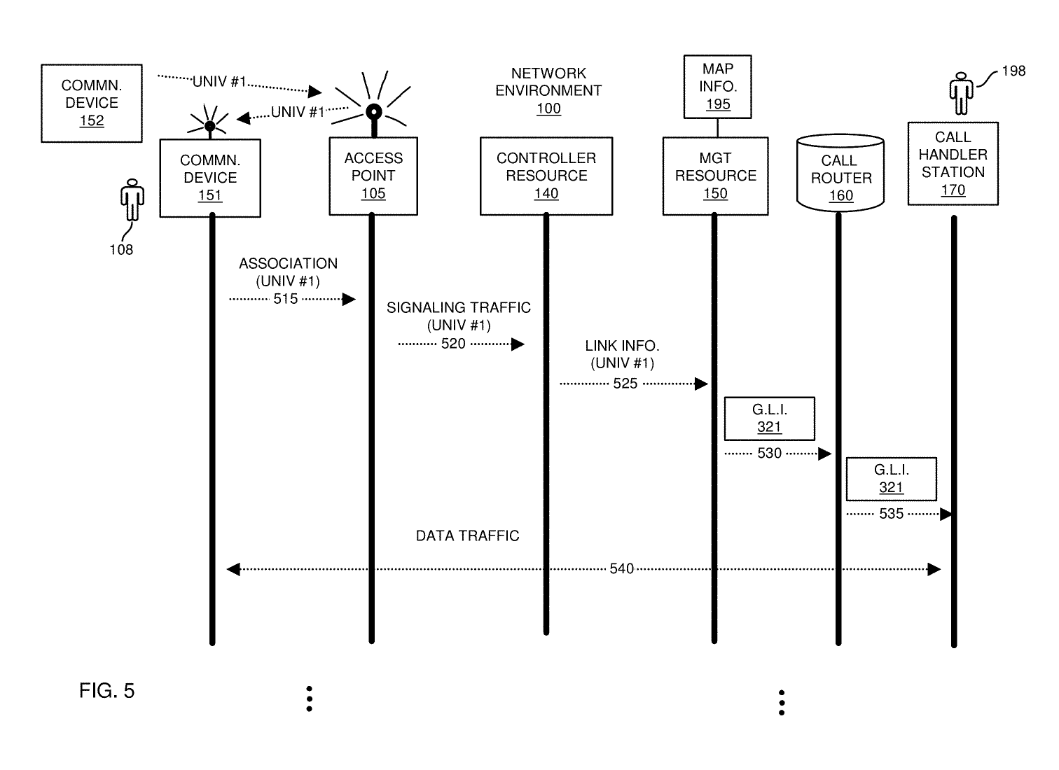

FIG. 5 is an example diagram illustrating management of a first communication session and providing notification of location information according to embodiments herein.

As previously discussed, the communication device 152 (or other suitable resource) distributes unique network identifier value UNIV#1 to the wireless access point 105. In response to receiving the unique network identifier value UNIV#1, the wireless access point 105, in turn, allocates a new sub-network for handling a corresponding predetermined type of communications such as 911 or emergency communications requesting assistance. If desired, the wireless access point 105 assigns the unique network identifier value UNIV#1 to be the name of the newly created available network.

In one embodiment, the allocated network named UNIV#1 is an open network (no credentials are needed to access) in which any mobile communication devices in a vicinity of wireless access point 105 are able to use.

Assume further in this example that the user 108 operating the communication device 151 would like to make a call to personnel 198. In such an instance, the user 108 activates an appropriate application (previously installed) on the communication device 151 and inputs a respective request to communicate with personnel 198. In furtherance of placing a respective call, the application on the communication device 151 selects from the available networks (as indicated by SSID #1, SSID #2, UNIV#1, . . . ) supported by the wireless access point 105. In one embodiment, the wireless access point broadcasts these names (such as SSID #1, SSID #2, UNIV#1, . . . ) of available networks to communication devices in the geographical region 121 via one or more discovery probe responses wirelessly transmitted in the geographical region 121.

In furtherance of establishing a respective communication session as requested by the user 108, the application (such as a call management application) on the communication device 151 selects the network name UNIV#1 to establish the respective communication session with wireless access point 105 in order to connect the user 108 to personnel 198 and call handler station 170.

In one embodiment, the unique network identifier value UNIV#1 is an ESSID value, indicating that the unique network identifier value UNIV#1 supports emergency type communications. In other words, a value or symbol in the unique network identifier value (such as the letter E) can indicate to the call management application on the communication device 151 that the unique network identifier value is reserved for emergency type calls.

Accordingly, in this example embodiment, in response to detecting input from the user 108 to make an emergency call (and establish the communication session), the application (such as application 240 in FIG. 2) executed on the communication device 151 selects the unique network identifier value UNIV#1.

During the association phase of establishing the respective communication session, via communications 515, the communication device 151 conveys the network identifier UNIV#1 name to the wireless access point 105. This notifies the wireless access point 105 that the communication device 151 would like to establish a respective communication session over the available network identified by identifier value UNIV#1.

Via further communications 515, the communication device 151 and wireless access point 105 establish a respective wireless communication session.

Wireless access point 105 provides notification of the newly created wireless communication session (between the communication device 151 and the wireless access point 105) to the controller resource 140 via communications 520. For example, in one embodiment, the wireless access point 105 notifies the controller resource 140 of the communication session and, more specifically, that the communication session with the user 108 has been established over the available network as specified by UNIV#1 (such as ESSID1).

Via further communications 525, controller resource 140 forwards link information associated with the communication session (including the unique network identifier value UNIV#1) to the management resource 150. Accordingly, the management resource 150 is made aware that the user 108 operating the communication device 151 has attempted and/or established a wireless communication session to communicate with personnel 198 at call handler station 170.

In response to receiving the link information associated with the communication session, the management resource 150 utilizes the map information 195 to retrieve location information indicating a geographical region in which the mobile communication device 151 resides. More specifically, the management resource 150 maps the unique network identifier value UNIV#1 (associated with the established communication session) to corresponding geographical location information 321, which describes a whereabouts of geographical region 121.

Via further communications 530, the management resource 150 forwards the retrieved geographical location information 321 to the call router 160. The call router 160, which may or may not use the contents of the geographical location information 321 to determine how to route the corresponding call alert, forwards the geographical location information 321, and potentially any other suitable information, to personnel 198 at the call handler station 170.

Additionally, note that the controller resource 140 (or other suitable entity) in network environment 100 can be configured to forward additional information about the communication device 151 such as a phone number assigned to the communication device, name associated with user 108, residential address of the user 108, criminal record of the user 108, medical history of the user 108, etc.

Accordingly, subsequent to assignment of a respective unique network identifier value to wireless access point 105, use of the unique network identifier value UNIV#1 and corresponding mapping as described herein provides a way of notifying personnel 198 of a respective location of a communication device making a call.

In addition to the signaling as discussed above, in which the wireless access point 105 provides notification of its location via forwarding of a unique value (such as UNIV#1) assigned to the wireless access point 105, the communication device 151 uses the established communication session to communicate (via communications 540) from the communication device 151 to the personnel 198 at the call handler station 170.

For example, subsequent to establishing the respective wireless communication session, via communications 540, the communication device 151 is able to transmit any type of information (voice communications generated by the user 108, image information, etc.) to the personnel 198 at call handler station 170.

In one embodiment, the user operates the communication device 151 to capture one or more images in a vicinity of the geographical region 121 and forwards the corresponding captured one or more images via communications 540 to the call handler station 170. In this manner, the personnel 198 at the call handler station 170 is able to view images provided by the user 108 of the communication device 151.

Additionally, the user operating communication device 151 can speak into the communication device 151. The communication device 151 conveys the corresponding audio signal over the wireless communication session to access point 105. The access point 105 forwards the audio signal via communications 540 to the personnel 198 at call handler station 170. Accordingly, the personnel 198 at the call handler station 170 are able to receive voice communications originating from the user 108.

In a similar manner, in a reverse direction, the personnel 198 (one or more call-handling persons) at the call handler station 170 are able to communicate different types of information such as audio information, image information, etc., over the respective network to the wireless access point 105. The wireless access point 105 further conveys the information to the communication device 151, where the communication device 151 plays back the information to the user 108 via a display screen and speaker of the communication device 151.

Thus, the location-tracked unique network identifier value UNIV#1 as described herein supports call connectivity as well as a way to a location of the communication device making a particular type of call.

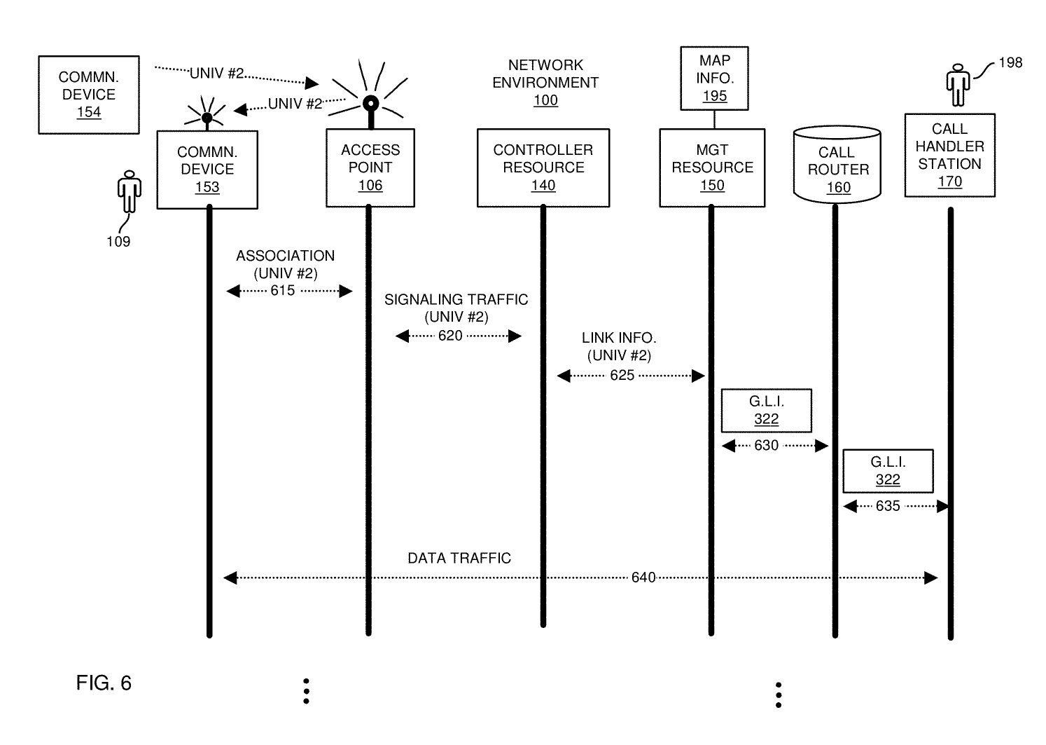

FIG. 6 is an example diagram illustrating management of a second communication session and providing notification of location information according to embodiments herein.

As previously discussed, the communication device 154 (or other suitable resource) distributes unique network identifier value UNIV#2 to the wireless access point 106.

In response to receiving the unique network identifier value UNIV#2, the wireless access point 106, in turn, allocates a new sub-network for handling a corresponding predetermined type of communications. If desired, the wireless access point 106 assigns the unique network identifier value UNIV#2 to be the name of the newly created available network.

In one embodiment, the allocated network named UNIV#2 is an open network (no credentials are needed) in which any mobile communication devices in a vicinity of wireless access point 106 in geographical region 122 are able to use.

Assume further in this example that the user 109 operating communication device 153 would like to make a call to personnel 198. In such an instance, the user 109 activates an appropriate application (previously installed) on the communication device 153 and inputs a respective request to communicate with personnel 198. In furtherance of placing a respective call, the application on the communication device 153 selects from the available networks (as indicated by SSID #3, SSID #4, UNIV#2, . . . ) supported by the wireless access point 106.

In one embodiment, the wireless access point 106 broadcasts these names (such as SSID #1, SSID #2, UNIV#1, . . . ) of available networks to communication devices in the geographical region 122 via one or more discovery responses wirelessly transmitted in the geographical region 122.

In furtherance of establishing a respective communication session as requested by the user 109, the application (such as a call management application) on the communication device 153 selects the network name UNIV#2 to establish the respective communication session, connecting the user 109 to personnel 198 and call handler station 170.

In one embodiment, the unique network identifier value UNIV#2 is an ESSID value, indicating that the unique network identifier value UNIV#2 supports emergency type communications. In other words, a value or symbol in the unique network identifier value (such as the letter E) can indicate to the call management application on the communication device 153 that the unique network identifier value UNIV#2 is reserved for emergency type calls.

Accordingly, in this example embodiment, in response to detecting input from the user 109 to make an emergency call (and establish the communication session), the application executed on the communication device 153 selects the unique network identifier value UNIV#2.

During the association phase of establishing the respective communication session, via communications 615, the communication device 153 conveys the network identifier UNIV#2 name to the wireless access point 106. This notifies the wireless access point 106 that the communication device 153 would like to establish a respective communication session over the available network identified by identifier value UNIV#2.

Via further communications 615, the communication device 153 and wireless access point 106 establish a respective wireless communication session.

Wireless access point 106 provides notification of the newly created wireless communication session (between the communication device 153 and the wireless access point 106) to the controller resource 140 via communications 620. For example, in one embodiment, the wireless access point 106 notifies the controller resource 140 of the communication session and, more specifically, that the communication session with the user 109 has been established over the available network as specified by UNIV#2 (such as ESSID2).

Via further communications 625, controller resource 140 forwards link information associated with the communication session (including the unique network identifier value UNIV#2) to the management resource 150. Accordingly, the management resource 150 is made aware that the user 109 operating the communication device 153 has established a wireless communication session to communicate with personnel 198 at call handler station 170.

In response to receiving the link information associated with the communication session, the management resource 150 utilizes the map information 195 to retrieve location information indicating a geographical region in which the mobile communication device 153 resides. More specifically, the management resource 150 maps the unique network identifier value UNIV#2 (associated with the established communication session) to corresponding geographical location information 322, which describes a whereabouts of geographical region 122.

Via further communications 630, the management resource 150 forwards the retrieved geographical location information 322 to the call router 160. The call router 160, which may or may not use the contents of the geographical location information 322 to determine how to route the corresponding call alert, forwards the geographical location information 322, and potentially any other suitable information, to personnel 198 at the call handler station 170.

Accordingly, subsequent to assignment of a respective unique network identifier value to wireless access point 106, the subsequent use of the unique network identifier value UNIV#2 and corresponding mapping as described herein provides a way of notifying personnel 198 of a respective location of a communication device making a call.

In addition to the signaling as discussed above, in which the wireless access point 106 provides notification of its location via forwarding of a unique value (such as UNIV#1) assigned to the wireless access point 106, the communication device 153 uses the established communication session to communicate (via communications 640) from the communication device 153 to the personnel 198 at the call handler station 170.

For example, subsequent to establishing a respective wireless communication session, via communications 640, the communication device 153 is able to transmit any type of information (voice communications generated by the user 109, image information, etc.) to the personnel 198 at call handler station 170. In one embodiment, the user operates the communication device 153 to capture one or more images in a vicinity of the geographical region 122 and forwards the corresponding captured one or more images via communications 640 to the call handler station 170. In this manner, the personnel 198 at the call handler station 170 is able to view images provided by the user 109 of the communication device 153.

Additionally, the user operating communication device 153 can speak into the communication device 153. The communication device 153 conveys the corresponding audio signal over the wireless communication session to access point 106. The access point 106 forwards the audio signal via communications 640 to the personnel 198 at call handler station 170. Accordingly, the personnel 198 at the call handler station 170 are able to receive voice communications originating from the user 109.

In a similar manner, in a reverse direction, the personnel 198 (one or more call-handling persons) at the call handler station 170 are able to communicate different types of information such as audio information, image information, etc., over the respective network to the wireless access point 106. The wireless access point 106 further conveys the information to the communication device 153, where the communication device 153 plays back the information to the user 109 via a display screen and speaker of the communication device 153.

Thus, the location-based unique network identifier value UNIV#2 as described herein supports call connectivity as well as a way to provide notification of location information associated with the communication device making a call.

Referring again to FIG. 1, note that the communication device 152 can include a corresponding sensor to detect any of one or more different types of trigger events. In one embodiment, in response to detecting a trigger event such as opening of an emergency exit door monitored by the sensor, the communication device 152 initiates communications to the call handler station 170 to notify personnel that the emergency door was opened.

Notification to the personnel 198 in this example can be achieved in any suitable manner. For example, in one embodiment, the communication device 152 can be configured to establish a wireless communication session with wireless access point 105. In a similar manner as previously discussed, the wireless access point 105 forwards information about the communication session over network 190 to control resource 140 management resource 150. The management resource 150 maps the unique identifier value UNIV#1 to the corresponding geographical region 121, notifying the personnel 198 at call handler station 170 that the trigger event occurred in the geographical region 121.

Alternatively, the communication device 152 can be connected directly to network 190 via hard-wired link. In response to detecting a trigger event, the communication device 152 communicates message information indicating occurrence of the trigger event over network 190 to controller resource 140. The controller resource 140 forwards the corresponding message information in any suitable manner to the call handler station 170 for handling by personnel 198.

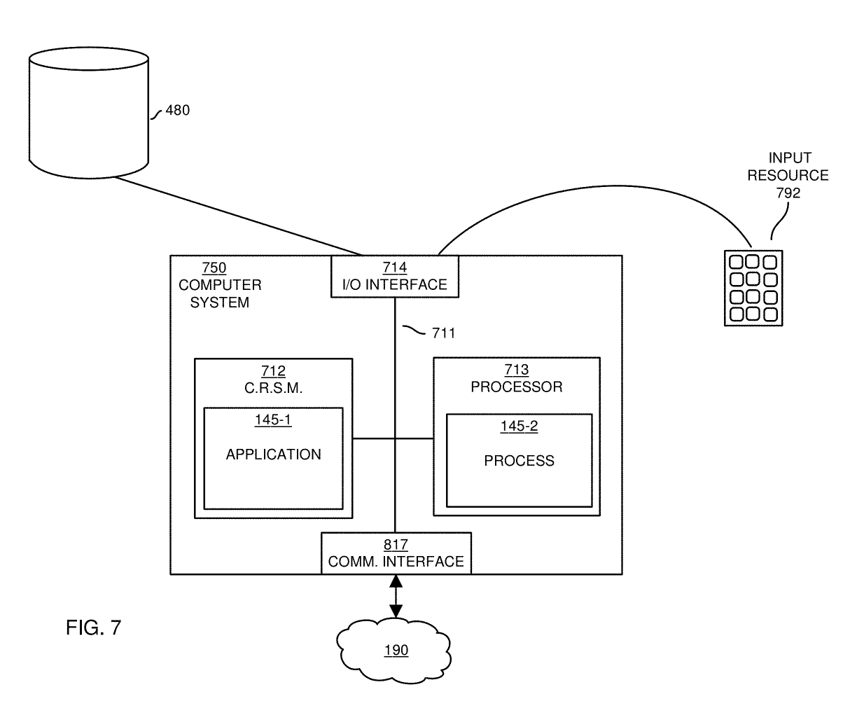

FIG. 7 is an example block diagram of a computer system for implementing any of the operations as discussed herein according to embodiments herein.

Any of the resources (e.g., communication device, wireless access point, controller resource, management resource, call router, call handler station, etc.) can be configured to include a processor and executable instructions to carry out the different operations as discussed herein.

As shown, computer system 750 of the present example can include an interconnect 711 that couples computer readable storage media 712 such as a non-transitory type of media (i.e., any type of hardware storage medium) in which digital information can be stored and retrieved, a processor 713 (computer processor hardware), I/O interface 714, and a communications interface 717.

Computer readable storage medium 712 can be any hardware storage device such as memory, optical storage, hard drive, floppy disk, etc. In one embodiment, the computer readable storage medium 712 stores instructions and/or data.

As shown, computer readable storage media 712 can be encoded with application 145-1 (e.g., including instructions) to carry out any of the operations as discussed herein.

During operation of one embodiment, processor 713 accesses computer readable storage media 712 via the use of interconnect 711 in order to launch, run, execute, interpret or otherwise perform the instructions in application 145-1 stored on computer readable storage medium 712. Execution of the application 145-1 produces process 145-2 to carry out any of the operations and/or processes as discussed herein.

Those skilled in the art will understand that the computer system 750 can include other processes and/or software and hardware components, such as an operating system that controls allocation and use of hardware resources to application 145-1.

In accordance with different embodiments, note that computer system may be or included in any of various types of devices, including, but not limited to, a mobile computer, a personal computer system, a wireless device, base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc.

The computer system 750 may reside at any location or can be included in any suitable resource in any network environment to implement functionality as discussed herein.

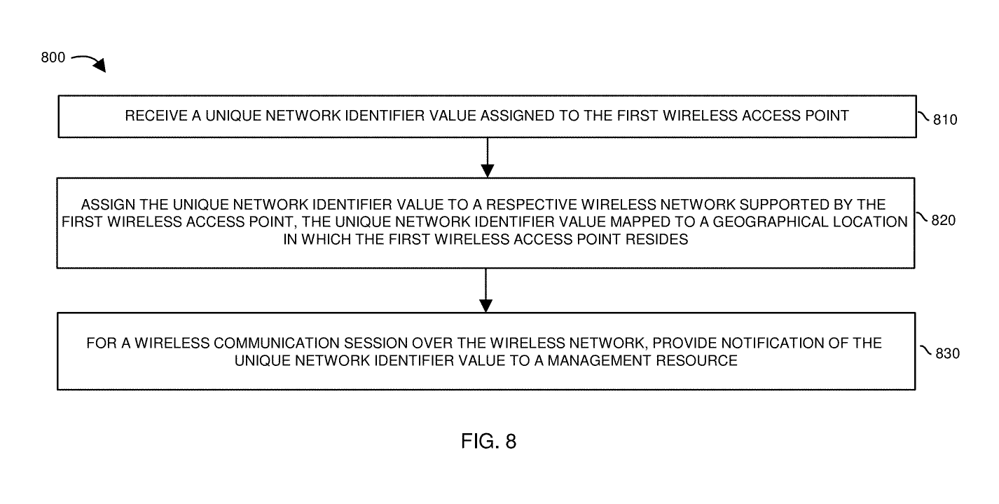

Functionality supported by the different resources will now be discussed via flowcharts in FIGS. 8-11. Note that the steps in the flowcharts below can be executed in any suitable order.

FIG. 8 is a flowchart 800 illustrating an example method according to embodiments. Note that there will be some overlap with respect to concepts as discussed above.

In processing operation 810, the wireless access point 105 receives a unique network identifier value assigned to the first wireless access point 105 and/or region in which the wireless access point 105 resides.

In processing operation 820, the wireless access point 105 assigns the unique network identifier value to a respective wireless network available from the first wireless access point. In one embodiment, the unique network identifier value is mapped to a geographical location in which the first wireless access point resides.

In processing operation 830, the wireless access point 105 provides notification of the unique network identifier value for the communication session to a call handling resource (such as a management resource).

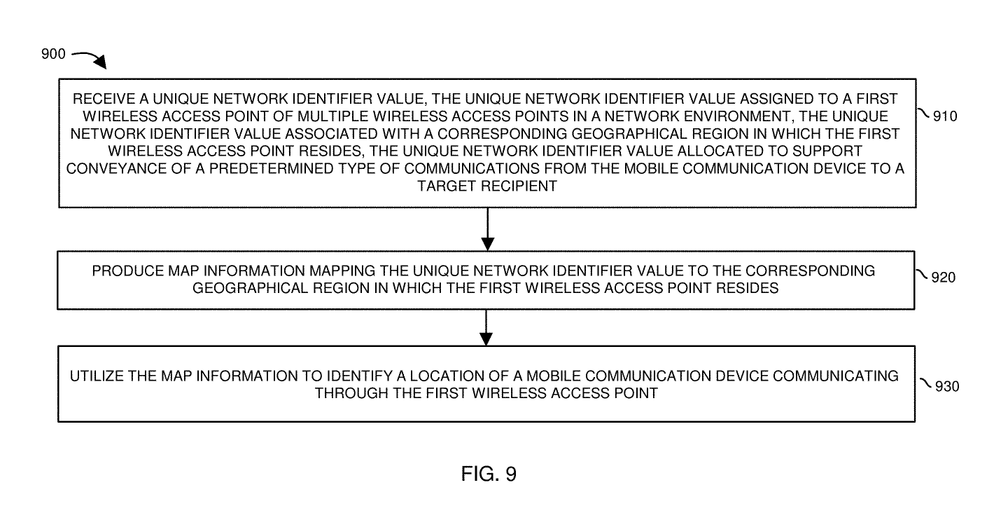

FIG. 9 is a flowchart 900 illustrating an example method according to embodiments. Note that there will be some overlap with respect to concepts as discussed above.

In processing operation 910, the wireless access point 105 receives a unique network identifier value UNV#1. The unique network identifier value (UNIV#1) is assigned to the first wireless access point 105, which is one of multiple wireless access points in network environment 100. The unique network identifier value UNIV#1 is associated with a corresponding geographical region 121 in which the first wireless access point 105 resides. The unique network identifier value UNIV #1 is allocated to support conveyance of a predetermined type of communications from the mobile communication device to a target recipient (such as operator 198 at call handler station 170).

In processing operation 920, the service provider produces map information 195 mapping the unique network identifier value UNIV #1 to the corresponding geographical region 121 in which the first wireless access point 105 resides.

In processing operation 930, the management resource 195 (or other suitable entity) utilizes the map information 195 to identify the location of a mobile communication device 151 establishing a communication session and communicating through the first wireless access point 105.

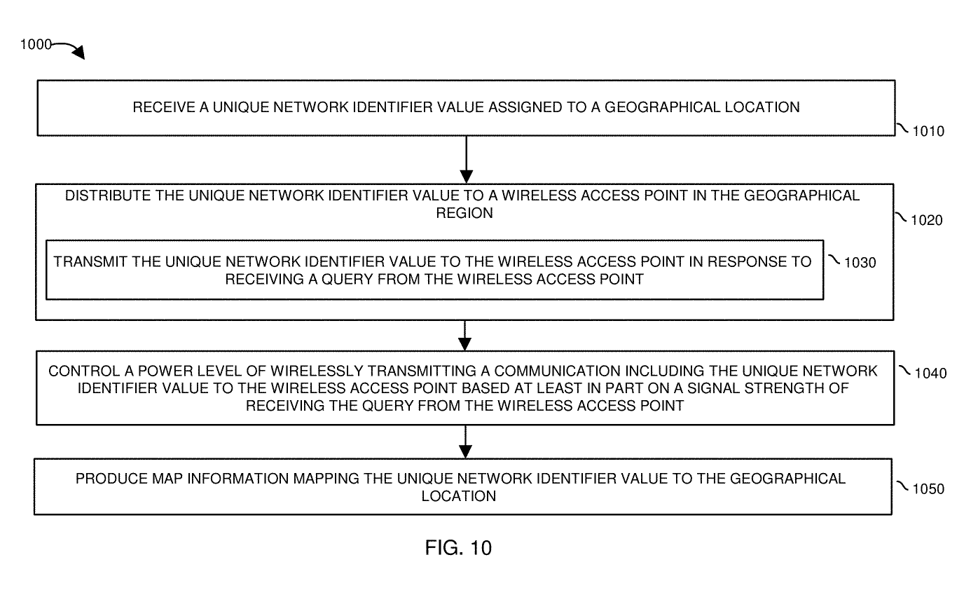

FIG. 10 is a flowchart 1000 illustrating an example method according to embodiments. Note that there will be some overlap with respect to concepts as discussed above.

In processing operation 1010, the communication device 152 receives a unique network identifier value UNIV#1 assigned to geographical location 121.

In processing operation 1020, the communication device 152 distributes the unique network identifier value UNIV#1 to a wireless access point 105 in the geographical region 121.

In sub-processing operation 1030, the communication device 152 transmits the unique network identifier value UNIV#1 to the wireless access point 105 in response to receiving a query from the wireless access point 105.

In processing operation 1040, the communication device 152 controls a power level of wirelessly transmitting assignment information communications including the unique network identifier value UNIV#1 to the wireless access point 105 based at least in part on a signal strength of receiving the query from the wireless access point 105.

In processing operation 1050, the communication device 152 produces map information 190 mapping the unique network identifier value UNIV#1 to the geographical location information 321 indicating geographical location 121.

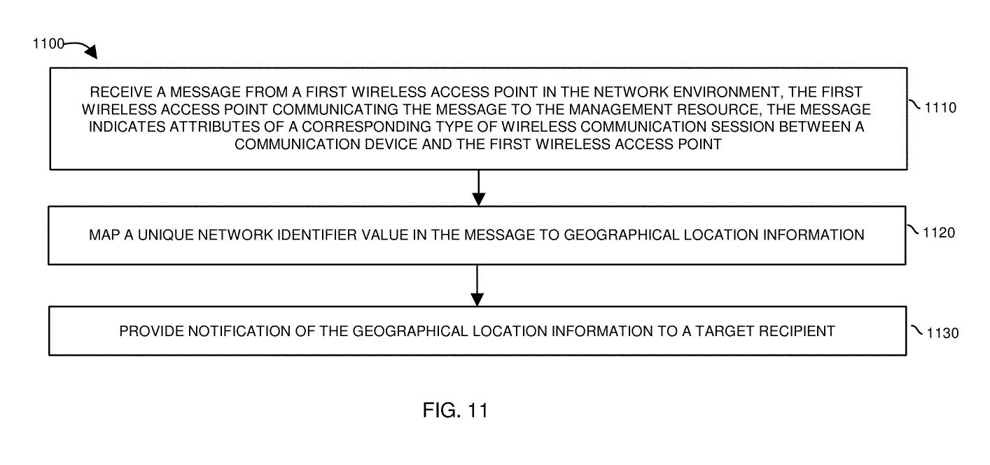

FIG. 11 is a flowchart 1100 illustrating an example method according to embodiments. Note that there will be some overlap with respect to concepts as discussed above.

In processing operation 1110, the management resource 150 receives a message via respective communications from the first wireless access point 105 in the network environment 100. The first wireless access point 105 communicates the message to the management resource 150 in response to the communication device 151 establishing a respective communication session with the wireless access point 105. In one embodiment, the message includes and/or identifies unique network identifier value UNIV#1, which indicates attributes of the corresponding type of wireless communication session between the communication device 151 and the first wireless access point 105.

In processing operation 1120, the management resource 150 maps the unique network identifier value UNIV#1 in the message to geographical location information 321.

In processing operation 1130, the management resource 150 provides notification of the geographical location information 321 to a target recipient.

Note again that techniques herein are well suited to facilitate, at a remote location, detecting a location of a communication device in a network environment. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

I claim:

1. A method comprising:
at a first wireless access point in a network environment including multiple wireless access points:
receiving a unique network identifier value assigned to the first wireless access point;
assigning the unique network identifier value to a respective wireless network supported by the first wireless access point, the unique network identifier value mapped to a geographical location in which the first wireless access point resides; and
for a wireless communication session over the wireless network, providing notification of the unique network identifier value to a management resource.

2. The method as in claim 1, wherein a communication device establishes the communication session with the first wireless access point, the method further comprising:
providing the notification of the unique network identifier value to the management resource to notify the management resource that the communication device establishing the communication session with the first wireless access point resides at the geographical location.

3. The method as in claim 1 further comprising:
from the first wireless access point: transmitting the unique network identifier value to the communication device to notify the communication device of an availability of the respective wireless network, the communication device within wireless communication range of the first wireless access point.

4. The method as in claim 1, wherein the unique network identifier value is allocated to indicate an identity of the respective wireless network, the respective wireless network dedicated to support a predetermined type of communications.

5. The method as in claim 1, wherein the unique network identifier value is a unique SSID (Service Set IDentifier) value indicating an identity of the respective wireless network supported by the first wireless access point.

6. The method as in claim 5 further comprising:
broadcasting the unique network identifier value in the geographical region to a communication device establishing the communication session, the unique network identifier value indicating availability of the respective wireless network to handle a predetermined type of communications.

7. The method as in claim 1 further comprising:
subsequent to providing notification of the unique network identifier value to the communication device, establishing the communication session between the first wireless access point and the communication device in response to a request from the communication device to establish the communication session over the respective wireless network.

8. The method as in claim 1 further comprising:
at the management resource, mapping the unique network identifier value to the geographical location in which the first wireless access point resides to identify a location of the communication device.

9. The method as in claim 8, wherein the management resource maps the unique network identifier value to geographical location information indicating the geographical location in which the first wireless access point resides; and
wherein the geographical location information includes a multiple-digit string of numbers specifying the geographical location in which the first wireless access point resides.

10. The method as in claim 9, wherein a first grouping of numbers of the string indicates an area code in which the first wireless access point resides;
wherein a second grouping of numbers in the string indicates an exchange within the area code in which the first wireless access point resides; and
wherein a third grouping of numbers in the string indicates a specific location of the first wireless access point in which the geographical region resides.

11. The method as in claim 1, wherein the unique network identifier value maps to geographical location information indicating the geographical location in which the first wireless access point resides; and
wherein the geographical location information includes a multiple-digit string of numbers, each of multiple groupings of numbers in the string corresponding to a successively more specific location of the geographical region in which the first wireless access point.

12. A method comprising:
via computer processor hardware, performing operations of:
receiving a unique network identifier value, the unique network identifier value assigned to a first wireless access point of multiple wireless access points in a network environment, the unique network identifier value associated with a corresponding geographical region in which the first wireless access point resides;
producing map information mapping the unique network identifier value to the corresponding geographical region in which the first wireless access point resides; and
utilizing the map information to identify a location of a mobile communication device communicating through the first wireless access point.

13. The method as in claim 11, wherein the unique network identifier value is allocated to support conveyance of a predetermined type of communications from the mobile communication device to a target recipient.

14. The method as in claim 13, wherein the unique network identifier value is a unique SSID (Service Set IDentifier) value assigned to a corresponding network supported by the first wireless access point.

15. A method comprising:
receiving a unique network identifier value assigned to a geographical location;
distributing the unique network identifier value to a wireless access point in the geographical region; and
producing map information mapping the unique network identifier value to the geographical location.

16. The method as in claim 15, wherein distributing the unique network identifier value includes: transmitting the unique network identifier value to the wireless access point in response to receiving a query from the wireless access point.

17. The method as in claim 16 further comprising:
controlling a power level of wirelessly transmitting a communication including the unique network identifier value to the wireless access point based at least in part on a signal strength of receiving the query from the wireless access point.

18. The method as in claim 15 further comprising:
adjusting a power level of wirelessly transmitting a communication including the unique network identifier value to control which of multiple wireless access points are assigned the unique network identifier value.

19. The method as in claim 15, wherein distribution of the unique network identifier value to the wireless access point notifies the wireless access point that the unique network identifier value is assigned for use by the wireless access point to support communications with mobile communication devices.

20. A method comprising:
at a management resource in a network environment including multiple wireless access points:
receiving a message from a first wireless access point in the network environment, the first wireless access point communicating the message to the management resource;
mapping a unique network identifier value in the message to geographical location information; and
providing notification of the geographical location information to a target recipient.

21. The method as in claim 20, wherein the message indicates attributes of a corresponding type of wireless communication session between a communication device and the first wireless access point.

22. The method as in claim 21, wherein the wireless communication session supports voice communications between the communication device and the first wireless access point, the first wireless access point forwarding communications received over the wireless communication session to the target recipient.

23. The method as in claim 20, wherein the target recipient includes call-handling personnel trained to manage the type of communications received over the wireless communication session from a user operating the communication device.

24. The method as in claim 20, wherein the geographical location information is a multiple-digit string of numbers, a first grouping of numbers of the string indicating an area code in which the first wireless access point resides, a second grouping of numbers in the string indicating an exchange within the area code in which the first wireless access point resides, and a third grouping of numbers in the string indicating a specific location of the first wireless access point in which the geographical region resides.

25. The method as in claim 20, wherein the geographical location information is a multiple-digit string of numbers, each of multiple groupings of numbers in the string indicating a successively more specific location of the geographical region in which the first wireless access point resides.

26. A system comprising:
multiple wireless access points including a first wireless access point and a second wireless access point;
the first wireless access point operable to:
receive a unique network identifier value assigned to the first wireless access point, the unique network identifier value mapped to location information indicating a location in which the first wireless access point resides;
distribute the unique network identifier value to a communication device within wireless communication range of the first wireless access point; and
provide notification of the unique network identifier value to a management resource that obtains the location information using the unique network identifier information.

27. The system as in claim 26, wherein a communication device establishes the communication session with the first wireless access point, the first wireless access point further operable to:
provide the notification of the unique network identifier value to the management resource to notify the management resource that the communication device establishing the communication session with the first wireless access point resides at the geographical location.

28. The system as in claim 26, wherein the first wireless access point is further operable to: transmit the unique network identifier value to the communication device, the communication device within wireless communication range of the first wireless access point, the unique network identifier value indicating the wireless network supported by the first wireless access point.

29. The system as in claim 26, wherein the unique network identifier value is allocated to support a predetermined type of communications from the communication device to the first wireless access point.

30. The system as in claim 26, wherein the unique network identifier value is a unique SSID (Service Set IDentifier) value indicating an identity of the respective wireless network supported by the first wireless access point.

31. The system as in claim 30, wherein the first wireless access point is further operable to:
broadcast the unique network identifier value in the geographical region to a communication device, the unique network identifier value indicating availability of the respective wireless network to handle a predetermined type of communications.

32. The system as in claim 26, wherein the first wireless access point is further operable to:
subsequent to providing notification of the unique network identifier value to a communication device, establishing the communication session between the first wireless access point and the communication device in response to a request from the communication device to establish the communication link over the respective wireless network.

33. The system as in claim 26 further comprising:
a management resource operable to map the unique network identifier value to the geographical location in which the first wireless access point resides to identify a location of the communication device.

34. The system as in claim 33, wherein the unique network identifier value is mapped to geographical location information indicating the geographical location in which the first wireless access point resides; and
wherein the geographical location information includes a multiple-digit string of numbers specifying the geographical location in which the first wireless access point resides.

35. Non-transitory computer-readable storage media having instructions stored thereon, the instructions, when carried out by computer processor hardware, causes the computer processor hardware to:
receive a unique network identifier value assigned to a first wireless access point, the unique network identifier value mapped to location information indicating a location of the first wireless access point;
distribute the unique network identifier value to a communication device within wireless communication range of the first wireless access point; and
provide notification of the unique network identifier value to a management resource obtains the location information using the unique network identifier value.
